(19) United States
(12) Patent Application Publication
(10) Pub. No.: US 2002/0157289 A1
(43) Pub. Date: Oct. 31, 2002

(54) Decorative device having movable decorative members

(76) Inventor: Yeong Shyan Hsueh, Chong Ho City (TW)

Correspondence Address: Yeong Shyan HSUEH, P.O. Box 10-69, Chong Ho, Taipei, 235, TW

(21) Appl. No.: 09/847,745

(22) Filed: Apr. 30, 2001

(51) Int. Cl. G09F 1/00; B65D 73/00

(52) U.S. Cl. 40/124.01; 206/457; 150/106; 446/76

(57) ABSTRACT

A decorative device includes a plate having one or more partitions for forming one or more casings. One or more decorative members and a fluid may be received in each of the casings. The decorative members may float or may move in the fluid, such as the air or the colored liquid. The plate may be secured onto a bottom board or directly secured onto an object for enclosing the decorative member in the casings. The decorative device may include an adhesive material applied onto the bottom board for allowing the decorative device to be easily secured onto various kinds of objects.

### BACKGROUND OF THE INVENTION

1. Field of the Invention

The present invention relates to a decorative device, and more particularly to a decorative device having movable or floatable decorative members.

2. Description of the Prior Art

The objects 80, as shown in FIG. 1, such as the typical purses, the typical scoolbags, the typical pencil cases 80, the typical suitcases, the typical luggage members, the typical hand bags, etc., includes two side panels 81 closable with a zipper device 82 or the like. The objects 80 have no decorative devices applied or attached thereto, and include the outer surface that may only be applied with the patterns thereon only.

The present invention has arisen to mitigate and/or obviate the afore-described disadvantages of the conventional decorative devices.

### SUMMARY OF THE INVENTION

The primary objective of the present invention is to provide a decorative device including one or more movable or floatable decorative members received in one or more casings, for attaching onto various kinds of objects, and for decorative purposes.

In accordance with one aspect of the invention, there is provided a decorative device comprising a plate including one or more partitions formed therein for forming one or more casings therein, and at least one decorative member received in each of the casings.

A fluid is received in each of the casings for floating the decorative member.

A bottom board is further provided and attached to the plate for enclosing the decorative member in the casings. Or, an object including a surface secured onto the plate for enclosing the decorative member in the casings. The decorative device may include an adhesive layer or an adhesive material applied onto the bottom surface of the bottom board for allowing the decorative device to be easily attached or secured onto various kinds of objects.

Further objectives and advantages of the present invention will become apparent from a careful reading of a detailed description provided hereinbelow, with appropriate reference to accompanying drawings.

### BRIEF DESCRIPTION OF THE DRAWINGS

FIG. 1 is a perspective view of a typical object;

FIG. 2 is a perspective view of an object including a decorative device in accordance with the present invention attached thereon;

FIG. 3 is an exploded view of the object including the decorative device attached thereto;

FIG. 4 is a cross sectional view taken along lines 4-4 of FIG. 2; and

FIGS. 5, 6, 7, 8 are perspective views illustrating the applications or the attachments of the decorative device onto various kinds of objects.

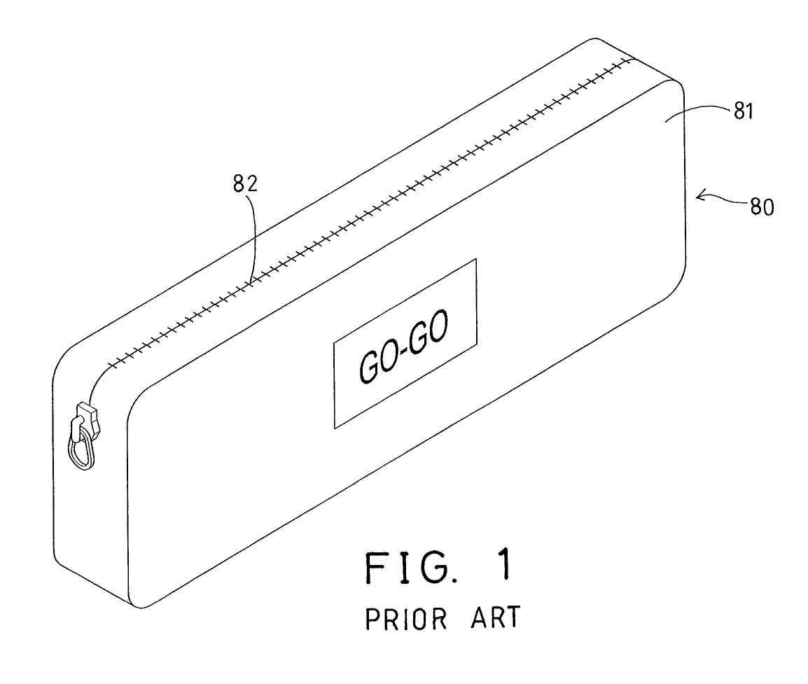

### DETAILED DESCRIPTION OF THE PREFERRED EMBODIMENT

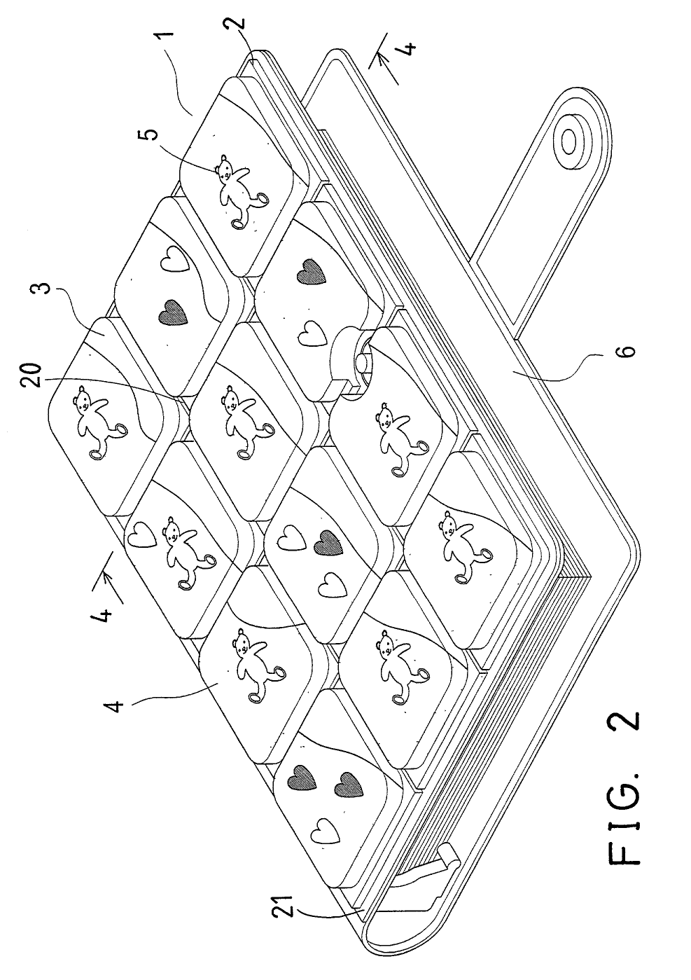

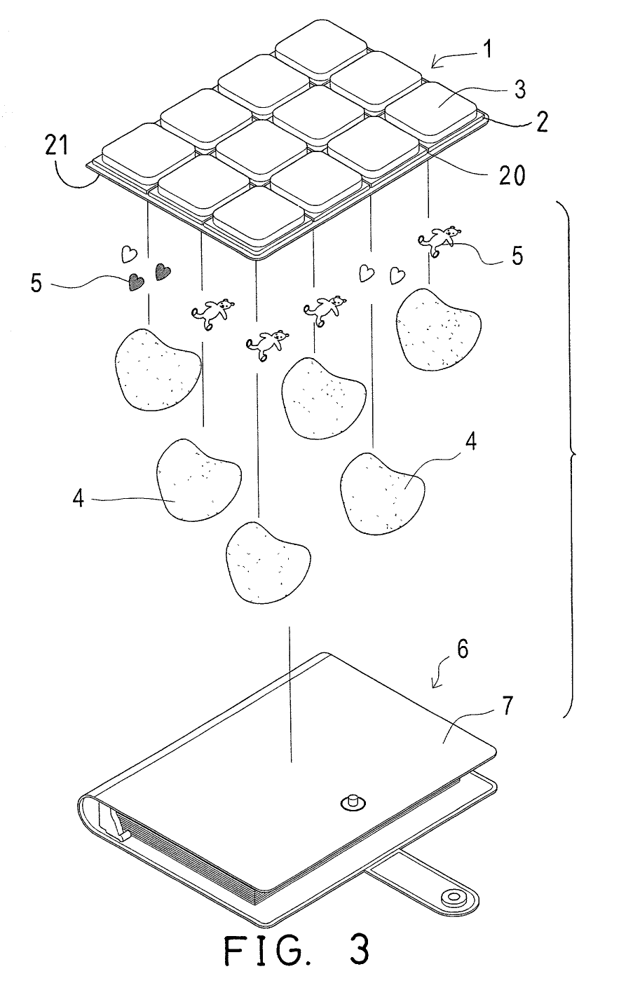

Referring to the drawings, and initially to FIGS. 2 and 3, a decorative device 1 in accordance with the present invention comprises a film or a sheet member or a plate 2 made of transparent or semi-transparent plastic materials and including one or more casings 3 formed therein and formed between partitions 20. One or more decorative members 5 are received in each of the casings 3, and a fluid 4, such as a gas or a liquid, particularly the colored liquid 4, is also received or filled in each of the casings 3, such that the decorative member 5 may float or may move in the fluid 4. The casings 3 and the decorative members 5 may be formed into various kinds of colors or shapes.

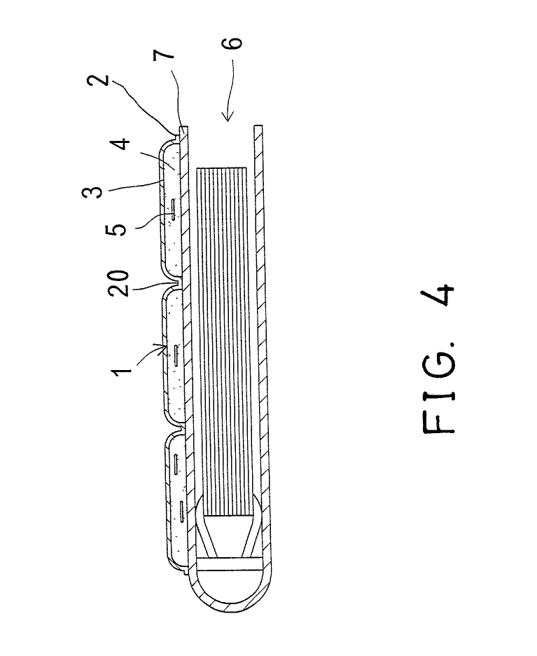

The decorative device 1 may further include a bottom board 21, the plate 2 is secured onto the board 21 with the adhesive materials or by welding processes, or the like. The bottom board 21 of the decorative device 1 may be attached onto the surfaces 7 of the objects 6 with the adhesive materials or by welding processes, or the like. Alternatively, as shown in FIG. 4, without the bottom board 21, the plate 2 may also be directly attached or secured onto the surfaces 7 of the objects 6 with the adhesive materials or by welding processes, or the like.

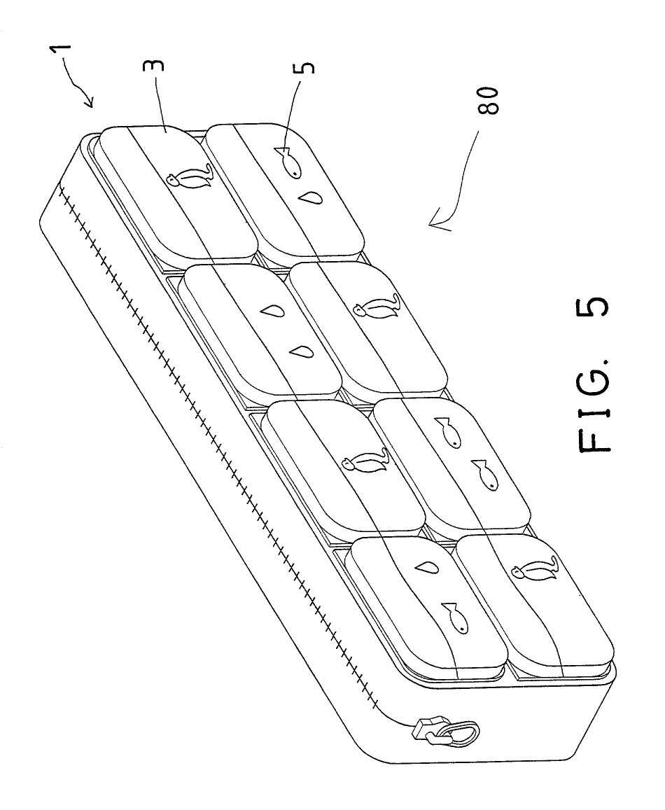

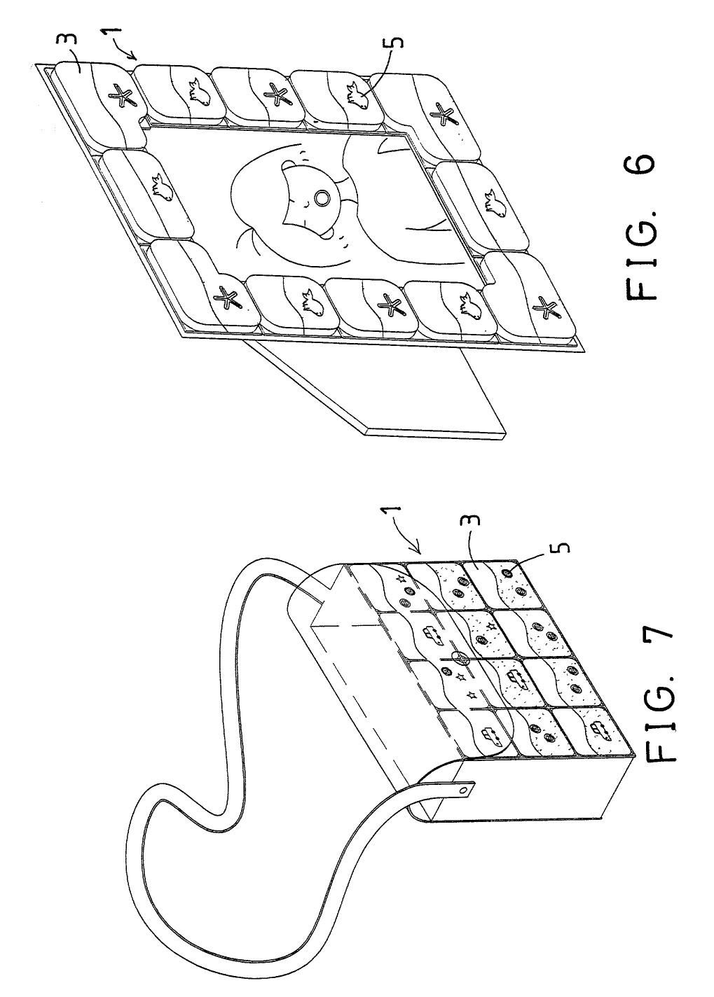

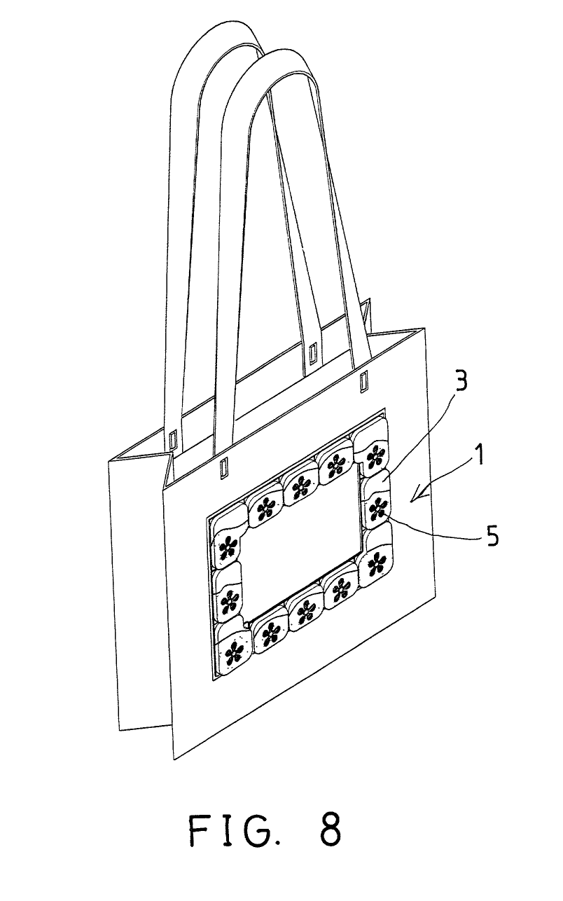

Referring next to FIGS. 5-8, the decorative device 1 may also be attached onto the other objects, such as the purses, the scoolbags, the pencil cases, the suitcases, the luggage members, the hand bags, etc., with or without the bottom board 21.

It is preferable that the decorative device 1 includes an adhesive layer or an adhesive material applied onto the bottom surface of the bottom board 21, for allowing the users to easily attach or secure the decorative device 1 onto various kinds of objects.

Accordingly, the decorative device in accordance with the present invention includes one or more movable or floatable decorative members received in one or more casings, for attaching onto various kinds of objects, and for decorative purposes.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A decorative device comprising:
a plate including at least one casing formed therein, and
at least one decorative member received in said at least one casing.

2. The decorative device according to claim 1 further comprising a fluid received in said at least one casing for floating said at least one decorative member.

3. The decorative device according to claim 1 further comprising a bottom board attached to said plate for enclosing said at least one decorative member in said at least one casing of said plate.

4. The decorative device according to claim 1 further comprising an object including a surface, said plate being secured onto said surface of said object for enclosing said at least one decorative member in said at least one casing of said plate.

5. A decorative device comprising:
a plate including a plurality of partitions formed therein for forming a plurality of casings therein, and
at least one decorative member received in each of said casings.

6. The decorative device according to claim 5 further comprising a fluid received in each of said casings for floating said at least one decorative member.

7. The decorative device according to claim 5 further comprising a bottom board attached to said plate for enclosing said at least one decorative member in said casings.

8. The decorative device according to claim 5 further comprising an object including a surface, said plate being secured onto said surface of said object for enclosing said at least one decorative member in said casings.

9. A decorative device comprising:
a plate including a plurality of partitions formed therein for forming a plurality of casings therein,
at least one decorative member received in each of said casing,
a fluid received in each of said casings for floating said at least one decorative member, and
means for enclosing said at least one decorative member in said casings.

10. The decorative device according to claim 9, wherein said enclosing means includes a bottom board attached to said plate for enclosing said at least one decorative member in said casings.

11. The decorative device according to claim 9, said enclosing means includes an object having a surface secured to said plate for enclosing said at least one decorative member in said casings.
